(19) United States
(12) Patent Application Publication
(10) Pub. No.: US 2014/0104540 A1
(43) Pub. Date: Apr. 17, 2014

(54) LIQUID CRYSTAL PANEL AND THE APPARATUS USING THE SAME

(71) Applicant: INNOLUX CORPORATION, Miao-Li County (TW)

(72) Inventors: SHU-HAN YU, Hsinchu City (TW); YUEH-HSING LI, Taipei City (TW); HUNG-ZE LIN, Chiayi County (TW); KAI-NENG YANG, Tainan City (TW); TSAU-HUA HSIEH, Hsinchu County (TW)

(73) Assignee: INNOLUX CORPORATION, Miao-Li County (TW)

(21) Appl. No.: 14/025,030

(22) Filed: Sep. 12, 2013

(30) Foreign Application Priority Data
Oct. 12, 2012 (TW) 101137748

(51) Int. Cl. G02F 1/1337

(52) U.S. Cl. CPC G02F 1/133719
USPC 349/61; 428/1.2

(57) ABSTRACT

This disclosure provides a LC panel and a LCD apparatus using the LC panel. The LC panel includes: a first substrate and a second substrate opposing the first substrate, arranging the first substrate to face the second substrate; a LC layer containing a plurality of LC molecules between the first substrate and second substrate; and a plurality of vertical alignment molecules, each comprising a long-chain alignment terminal, a cross-linking terminal, and at least one bonding terminal; wherein the at least one bonding terminal couples the vertical alignment molecule to the first or second substrate to form a surface bonding, the long-chain alignment terminals are parallel to each other and perpendicular to the first or second substrate, the cross-linking terminals link the neighboring vertical alignment molecules together, and the LC molecules are vertically aligned between the first substrate and second substrate by means of the long-chain alignment terminals.

This application claims the benefit of Taiwan application Serial No. 101137748, filed Oct. 12, 2012, the disclosure of which is incorporated by reference herein in its entirety.

### TECHNICAL FIELD

The present disclosure relates to the field of liquid crystal (LC) panel, and more particularly, to a LC panel without a polyimide alignment layer.

### TECHNICAL BACKGROUND

LC display has been intensely developed in the display industry for years, and a LC panel or cell can be the key device therein. The LC panel is basically composed of LC molecules sandwiched and sealed between two parallel glass substrates. To keep the LC molecules aligned in a predetermined incline direction (as referred to the pre-tilt angle), an alignment film is formed on the glass substrates. Usually the alignment film is made of polyimide (PI) uniformly coated on the substrates. After being baked and rubbed, the alignment film is capable of aligning the LC molecules. However, the fabrication of the alignment film would get along with its cost and may induce possible contaminations on the substrates, which negatively affects the LC panel's fabrication cost and yield.

Recently PI-free LC displays have been proposed, wherein the LC molecules are aligned due to the ultra-violet (UV) excitation. The reactive monomers in the LC solution may aggregate on the glass substrate after the UV light exposure to form a polymer layer which is capable of aligning the LC molecules. Thus no additional alignment film has to be coated in the PI-free LC displays, but the alignment stability and reliability of the LC molecules therein are not good enough. Consequently, it is in need to develop a new PI-free LC display.

### TECHNICAL SUMMARY

According to one aspect of the present disclosure, one embodiment provides a LC panel, which includes: a first substrate and a second substrate opposing the first substrate, arranging the first substrate to face the second substrate; a LC layer containing a plurality of LC molecules interposed between the first substrate and second substrate; and a plurality of vertical alignment molecules, each comprising a long-chain alignment terminal, a cross-linking terminal, and at least one bonding terminal; wherein the at least one bonding terminal couples the vertical alignment molecule to the first or second substrate to form a surface bonding, the long-chain alignment terminals are parallel to each other and perpendicular to the first or second substrate, the cross-linking terminals link the neighboring vertical alignment molecules together, and the LC molecules are vertically aligned between the first and second substrates by means of the long-chain alignment terminals.

Each of the vertical alignment molecules may further comprise either a Si atom or an N atom for bonding the long-chain alignment terminal, the cross-linking terminal, and the at least one bonding terminal.

The long-chain alignment terminal may comprise an alkyl group, an alkylene group, or a benzene-ring compound.

The bonding terminal may be selected from the group consisting of O—CH₂—C(Z)═CH₂, O—(CH₂)ₙ—O—CO—C(Z)═CH₂, (CH₂)ₙ—O—CO—C(Z)═CH₂, O—(CH₂)ₙ—C(Z)═CH₂, O—(CH₂—CH₂—O)ₙ—CO—C(Z)═CH₂, (CH₂—CH₂—O)ₙ—CO—C(Z)═CH₂, O—(CH₂—CH₂—O)ₙ—C(Z)═CH₂, (CH₂—CH₂—O)ₙ—C(Z)═CH₂, O—CO—C(Z)═CH₂, O—CH₃, O—C₂H₅, and O—H, wherein n is a positive integer and Z is a methyl group or a hydrogen group.

The cross-linking terminal may be selected from the group consisting of O—CH₂—C(Z)═CH₂, CH₂—C(Z)═CH₂, O—(CH₂)ₙ—O—CO—C(Z)═CH₂, (CH₂)ₙ—O—CO—C(Z)═CH₂, O—(CH₂)ₙ—C(Z)═CH₂, (CH₂)ₙ—C(Z)═CH₂, O—(CH₂—CH₂—O)ₙ—CO—C(Z)═CH₂, (CH₂—CH₂—O)ₙ—CO—C(Z)═CH₂, O—(CH₂—CH₂—O)ₙ—C(Z)═CH₂, (CH₂—CH₂—O)ₙ—C(Z)═CH₂, O—CO—C(Z)═CH₂, O—CH₃, O—C₂H₅, and O—H, wherein n is a positive integer and Z is a methyl group or a hydrogen group

According to another aspect of the present disclosure, another embodiment provides a LCD apparatus, which includes a backlight unit; and a LC panel comprising: a first substrate and a second substrate opposing the first substrate, arranging the first substrate to face the second substrate; a LC layer containing a plurality of LC molecules interposed between the first substrate and second substrate; and a plurality of vertical alignment molecules, each comprising a long-chain alignment terminal, a cross-linking terminal, and at least one bonding terminal; wherein the at least one bonding terminal couples the vertical alignment molecule to the first or second substrate to form a surface bonding, the long-chain alignment terminals are parallel to each other and perpendicular to the first or second substrate, the cross-linking terminals link the neighboring vertical alignment molecules together, and the LC molecules are vertically aligned between the first substrate and second substrate by means of the long-chain alignment terminals.

According to another aspect of the present disclosure, another embodiment provides a LC panel, which includes a first substrate and a second substrate opposing the first substrate, arranging the first substrate to face the second substrate; a LC layer containing a plurality of LC molecules interposed between the first substrate and second substrate; and a plurality of vertical alignment molecules interposed between the first substrate and the LC layer and between the second substrate and the LC layer, each vertical alignment molecule comprising a first terminal, a second terminal, and a third terminal; wherein the first terminal comprises one of an alkyl group, an alkylene group, and a benzene-ring compound, and one of the second and third terminals comprises an O atom.

The cross-linking terminal may have a photo-polymerization group for linking the cross-linking terminals of the neighboring vertical alignment molecules together after exposed to ultra-violet light.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 schematically shows a cross-sectional view of a LC panel according to one embodiment of the present disclosure.

FIG. 2A schematically shows a chemical structure in which a Si atom is the bonding element of the vertical alignment molecule in the first example.

FIG. 2B schematically shows a chemical structure in which an N atom is the bonding element of the vertical alignment molecule in the second example.

FIG. 3 schematically shows an enlarged diagram of the LC molecules and the vertical alignment molecules in the LC panel nearby the first substrate.

FIG. 4 schematically shows an enlarged diagram of the LC molecules and the vertical alignment molecules in the LC panel nearby the first substrate.

FIG. 5 schematically shows a LC display apparatus according to an embodiment of this disclosure.

### DESCRIPTION OF THE EXEMPLARY EMBODIMENTS

For further understanding and recognizing the fulfilled functions and structural characteristics of the disclosure, several exemplary embodiments cooperating with detailed description are presented as the following. Reference will now be made in detail to the preferred embodiments, examples of which are illustrated in the accompanying drawings.

In the following description of the embodiments, it is to be understood that when an element such as a layer (film), region, pattern, or structure is stated as being “on” or “under” another element, it can be “directly” on or under another element or can be “indirectly” formed such that an intervening element is also present. Also, the terms such as “on” or “under” should be understood on the basis of the drawings, and they may be used herein to represent the relationship of one element to another element as illustrated in the figures. It will be understood that this expression is intended to encompass different orientations of the elements in addition to the orientation depicted in the figures, namely, to encompass both “on” and “under”. In addition, although the terms “first”, “second” and “third” are used to describe various elements, these elements should not be limited by the term. Also, unless otherwise defined, all terms are intended to have the same meaning as commonly understood by one of ordinary skill in the art.

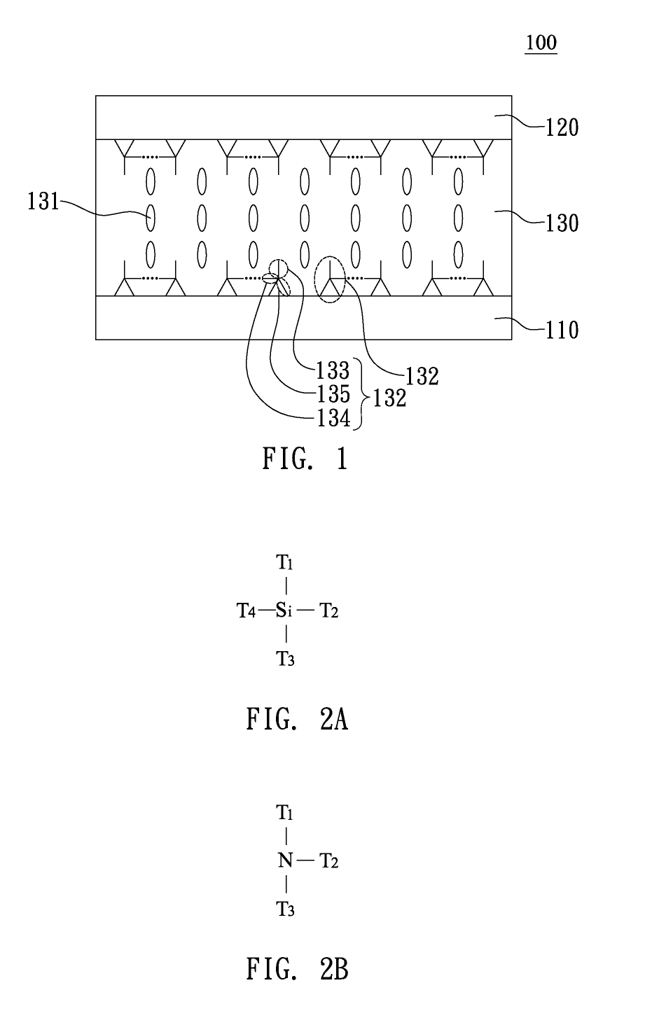

FIG. 1 schematically shows a cross-sectional view of a LC panel 100 according to one embodiment of the present disclosure. As shown in FIG. 1, the LC panel 100 includes a first substrate 110, a second substrate 120 opposing to the first substrate 110, and a LC layer 130 interposed between the first substrate 110 and the second substrate 120. The LC layer 130 may include a plurality of LC molecules 131 and a plurality of vertical alignment molecules 132, wherein each of the vertical alignment molecules 132 includes a long-chain alignment terminal 133, a cross-linking terminal 134, and at least one bonding terminal 135.

The bonding terminal 135 is designed to form a bond between the vertical alignment molecules 132 and either the first substrate 110 or the second substrate 120, so as to make the vertical alignment molecules 132 fixed onto the surface of the first substrate 110 or the second substrate 120. The long-chain alignment terminal 133 is designed to stand vertically on the substrate 110 or 120. In other words, the long-chain alignment terminal 133 can be parallel to each other and perpendicular to the surface of the first substrate 110 or the second substrate 120. Thus the vertical alignment is inherent in the vertical alignment molecules 132. Due to the vertical alignment of the vertical alignment molecules 132, the LC molecules 131 can be vertically aligned between the first substrate 110 and the second substrate 120. Thereby, the LC panel 100 can be used in the field of vertical alignment LC displays (VA-LCDs), in which the liquid crystals naturally align vertically to the glass substrates. Moreover, the cross-linking terminal 134 can link the neighboring vertical alignment molecules 132 together, so that the vertical alignment molecules 132 can be cross-linked to form a polymer film on the first substrate 110 or the second substrate 120. Thus the LC molecules 131 can be well aligned and the vertical alignment molecules 132 can be well polymerized, so as to alleviate light leakage in a LC panel caused by some LC alignment defects and hence improve the LCD's reliability.

Both the first substrate 110 and the second substrate 120 may be made of glass as glass substrates. But it is not limited thereto in this disclosure; they may also be insulation substrates, ceramic substrates, plastic substrates, or flexible substrates. The first substrate 110 may include a first electrode layer disposed thereon, which may be made of transparent conductive material, such as indium in oxide (ITO). The second substrate 120 may include a second electrode layer disposed thereon, which may be made of transparent conductive material, such as indium tin oxide (ITO). In the embodiment, the first substrate 110 is a thin-film transistor (TFT) substrate which is a glass substrate with a TFT layer formed thereon, and the second substrate 120 is a color filter (CF) substrate which is a glass substrate with a CF layer formed thereon. But it is not limited thereto in this disclosure, a CF substrate may be used as the first substrate 110 and a TFT substrate may be used as the second substrate 120.

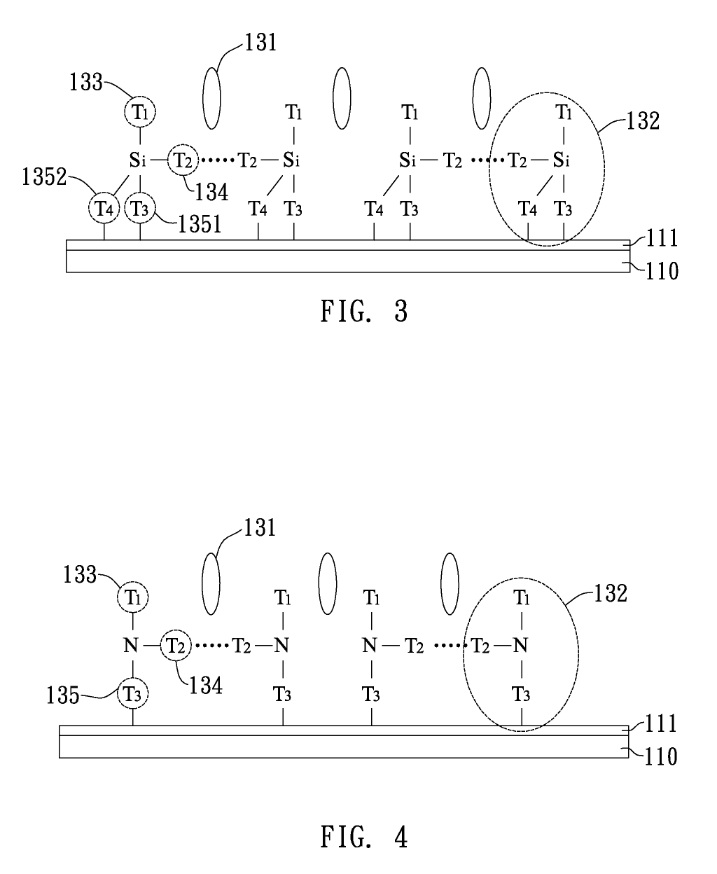

In the embodiment, the vertical alignment molecules 132 may further include either a silicon (Si) atom or a nitrogen (N) atom, which is an element for bonding the long-chain alignment terminal 133, the cross-linking terminal 134, and the at least one bonding terminal 135. In the following embodiments, a Si atom is used as the bonding element in a first example and an N atom as the bonding element in a second example. To describe the structure of the vertical alignment molecules 132, the relation between the vertical alignment molecules 132 and the LC molecules 131, and the relation between the vertical alignment molecules 132 and the substrate 110 or 120, FIGS. 3 and 4 schematically show part areas of the LC panel 100 nearby the first substrate 110 according to the first and second examples.

In the first example, a Si atom is used as the bonding element of the vertical alignment molecule 132, which can be a silane coupling agent with a chemical structure shown in FIG. 2A. T₁ may denote the long-chain alignment terminal 133, T₂ may denote the cross-linking terminal 134, and T₃ and T₄ may denote the bonding terminals 135. In case the first substrate 110 contains a first electrode layer 111 formed thereon, FIG. 3 schematically shows an enlarged diagram of the LC molecules 131 and the vertical alignment molecules 132 in the LC panel 100 nearby the first substrate 110. Each of the vertical alignment molecules 132 acts as a silane coupling agent including one long-chain alignment terminal 133, one cross-linking terminal 134, and two bonding terminals 1351 and 1352. The Si atom has 4 bonds coupled to the long-chain alignment terminal 133, the cross-linking terminal 134, the first bonding terminal 1351, and the second bonding terminal 1352, respectively.

As shown in FIG. 3, T₁ denotes the long-chain alignment terminal 133, which can be an alkyl group, an alkylene group, or a benzene-ring compound. For example, the alkyl group can be selected from the group consisting of CH₃, C₂H₅, C₃H₇, C₄H₉, C₅H₁₁, C₆H₁₃, C₇H₁₅, and C₈H₁₇, the alkylene group can be selected from the group consisting of C═C—C═C and C═C—C═C—C═C, and the benzene-ring compound can be selected from the group consisting of

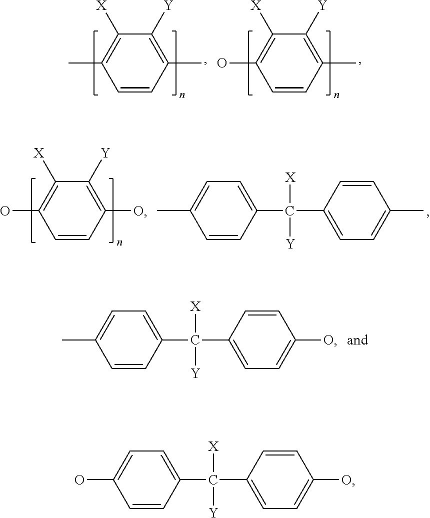

wherein n is a positive integer, X is selected from the group consisting of hydrogen (H), chlorine (Cl), fluorine (F), bromine (Br), iodine (I), hydroxyl group (OH) and CH₄, and Y is selected from the group consisting of H, Cl, F, Br, I, OH and CH₄. It should be understood that various vertical alignment molecules 132 in an individual LC panel may have different compositions of T₁ or the long-chain alignment terminal 133 from each other. That is, the vertical alignment molecules 132 can be a mixture of vertical alignment molecules with different compositions of T₁.

As shown in FIG. 3, T₃ and T₄ denote the first bonding terminal 1351 and the second bonding terminal 1352, respectively, each of which can contain an O atom, designed to form surface bonding to the first substrate 110 or the second substrate 120. For example, the first bonding terminal (T₃) 1351 may be selected from the group consisting of O—CH₂—C(Z)—CH₂, O—(CH₂)ₙ—O—CO—C(Z)═CH₂, (CH₂)ₙ—O—CO—C(Z)═CH₂, O—(CH₂)ₙ—C(Z)═CH₂, O—(CH₂—CH₂—O)ₙ—CO—C(Z)═CH₂, (CH₂—CH₂—O)ₙ—CO—C(Z)═CH₂, O—(CH₂—CH₂—O)ₙ—C(Z)═CH₂, (CH₂—CH₂—O)ₙ—C(Z)═CH₂, O—CO—C(Z)═CH₂, O—CH₃, O—C₂H₅, and O—H, and the second bonding terminal (T₄) 1352 may be selected from the group consisting of O—CH₂—C(Z)═CH₂, O—(CH₂)ₘ—O—CO—C(Z)═CH₂, (CH₂)ₘ—O—CO—C(Z)═CH₂, O—(CH₂)ₘ—C(Z)═CH₂, O—(CH₂—CH₂—O)ₘ—CO—C(Z)═CH₂, (CH₂—CH₂—O)ₘ—CO—C(Z)═CH₂, O—(CH₂—CH₂—O)ₘ—C(Z)═CH₂, (CH₂—CH₂—O)ₘ—C(Z)═CH₂, O—CO—C(Z)═CH₂, O—CH₃, O—C₂H₅, and O—H, wherein n can be an arbitrary positive integer, m is an arbitrary positive integer, and Z is a methyl group or a hydrogen group. It should be understood that various vertical alignment molecules 132 in an individual LC panel may have different compositions of the bonding terminals (T₃ and T₄) 1351 and 1352 from each other. That is, the vertical alignment molecules 132 can be a mixture of vertical alignment molecules with different compositions of T₃ and T₄, and in an individual vertical alignment molecule 132 the first bonding terminal (T₃) 1351 and the second bonding terminal (T₄) 1352 can be different from other.

As shown in FIG. 3, T₂ denotes the cross-linking terminal 134, which may be selected from the group consisting of O—CH₂—C(Z)═CH₂, O—(CH₂)ₙ—O—CO—C(Z)═CH₂, (CH₂)ₙ—O—CO—C(Z)CH₂, O—(CH₂)ₙ—C(Z)═CH₂, O—(CH₂—CH₂—O)ₙ—CO—C(Z)═CH₂, (CH₂—CH₂—O)ₙ—CO—C(Z)═CH₂, O—(CH₂—CH₂—O)ₙ—C(Z)═CH₂, (CH₂—CH₂—O)ₙ—C(Z)═CH₂, O—CO—C(Z)═CH₂, O—CH₃, O—C₂H₅, and O—H, wherein n can be an arbitrary positive integer and Z is a methyl group or a hydrogen group. It should be understood that various cross-linking terminal 134 in an individual LC panel may have different compositions of T₄ or the cross-linking terminals 134 from each other. That is, the vertical alignment molecules 132 can be a mixture of vertical alignment molecules with different compositions of T₂.

In one embodiment, bi-acrylic monomers can be added into the LC layer 130 before the photo polymerization. The bi-acrylic monomers are used to reinforce the alignment capacity of the vertical alignment molecules 132. For example, the bi-acrylic monomers can be made of 4,4′-bisacryloyl-biphenyl with its chemical formula

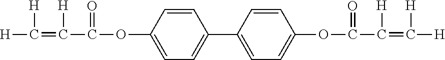 [SMILES: C=CC(=O)Oc1ccc(-c2ccc(OC(=O)C=C)cc2)cc1]

or 4,4′-bis[4-(acryloyxy) hexyloxy]biphenyl with its chemical formula

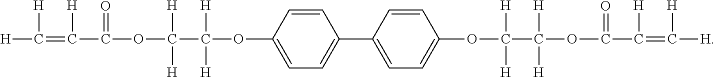

Moreover, the cross-linking terminal 134 may contain a photo-polymerization functional group, configured for linking the cross-linking terminals 134 of the neighboring vertical alignment molecules 132 together after exposed to ultra-violet (UV) light. A mercury lamp of middle, high or ultra-high pressure can be used to emit the UV light with its wavelength in the range from 100 nm to 400 nm. A photo-initiator may be added into the LC layer 130 to facilitate the cross-linking between the vertical alignment molecules 132 and the bi-acrylic monomers. For example, the photo-initiator can be made of phenyl ketone such as 1-hydroxy-cyclohexylphenyl-ketone with its chemical formula

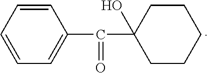 [SMILES: O=C(c1ccccc1)C1(O)CCCCC1]

In the second example, an N atom is used as the bonding element of the vertical alignment molecule 132 with its chemical structure shown in FIG. 2B. T₁ may denote the long-chain alignment terminal 133, T₂ may denote the cross-linking terminal 134, and T₃ may denote the bonding terminal 135. In case the first substrate 110 contains a first electrode layer 111 formed thereon, FIG. 4 schematically shows an enlarged diagram of the LC molecules 131 and the vertical alignment molecules 132 in the LC panel 100 nearby the first substrate 110. Each of the vertical alignment molecules 132 includes one long-chain alignment terminal 133, one cross-linking terminal 134, and one bonding terminals 135. The N atom has 3 bonds coupled to the long-chain alignment terminal (T₁) 133, the cross-linking terminal (T₂) 134, and the bonding terminal (T₃) 135, respectively. The descriptions of the long-chain alignment terminal T₁, the cross-linking terminal T₂, and the bonding terminal T₃ are very similar to those in the first example and hence are not recited redundantly.

In the embodiments, the surface bonding formed between the vertical alignment molecules 132 and the glass substrate 110 or 120 are used in the LC panel 100, so that the vertical alignment molecules 132 can be fixed onto the surface of the glass substrate 110 or 120. Due to the long-chain alignment terminal 133, the vertical alignment molecules 132 can stand vertically on the glass substrate 110 or 120, so that the LC molecules 131 can be vertically aligned between the glass substrates 110 and 120. Thus, forming a vertical alignment layer such as a polyimide (PI) film can be avoided in the fabrication process of the TFT and CF substrates. This makes the LC panel 100 in the embodiments excused from the problems due to the vertical-alignment film formation on the glass substrates, and makes the fabrication cost of the LC panel reduced, also.

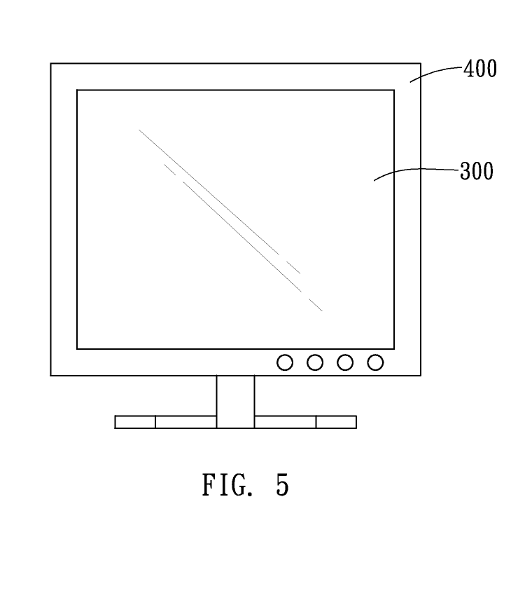

FIG. 5 schematically shows a LC display apparatus 400 according to an embodiment of this disclosure. The LC display apparatus 400 includes a LC panel 300 according to the above-recited embodiments. The LC display apparatus 400 can be a calculator with a monitoring screen, a mobile phone, a tablet computer, or a digital media frame with a controller integrated-circuit chip on a printed circuit board, but this disclosure is not limited thereto. The configuration of the LC panel 300 can be referred to the above-recited embodiments. Liquid crystals are matter in a state that has properties between those of conventional liquid and those of solid crystal. LCs may be composed of crystal-like organic molecules, which can be orientated according to external electrical fields. This is the operational principle of the LC display. Moreover, the LC display apparatus 400 can also be applied to the electronic products such as a television set, a personal computer, a monitoring screen, and a personal digital assistant (PDA).

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A liquid crystal (LC) panel comprising:
a first substrate and a second substrate opposing the first substrate, arranging the first substrate to face the second substrate;
a LC layer containing a plurality of LC molecules between the first substrate and second substrate; and
a plurality of vertical alignment molecules, each comprising a long-chain alignment terminal, a cross-linking terminal, and at least one bonding terminal;
wherein the at least one bonding terminal couples the vertical alignment molecule to the first or second substrate to form a surface bonding, the long-chain alignment terminals are parallel to each other and perpendicular to the first or second substrate, the cross-linking terminals link the neighboring vertical alignment molecules together, and the LC molecules are vertically aligned between the first and second substrates by means of the long-chain alignment terminals.

2. The LC panel according to claim 1, wherein each vertical alignment molecule further comprises either a Si atom or an N atom for bonding the long-chain alignment terminal, the cross-linking terminal, and the at least one bonding terminal.

3. The LC panel according to claim 1, wherein the long-chain alignment terminal comprises one of an alkyl group, an alkylene group, and a benzene-ring compound.

4. The LC panel according to claim 3, wherein the alkyl group is selected from the group consisting of CH₃, C₂H₅, C₃H₇, C₄H₉, C₅H₁₁, C₆H₁₃, C₇H₁₅, and C₈H₁₇.

5. The LC panel according to claim 3, wherein the alkylene group is selected from the group consisting of C═C—C═C and C═C—C═C—C═C.

6. The LC panel according to claim 3, wherein the benzene-ring compound is selected from the group consisting of 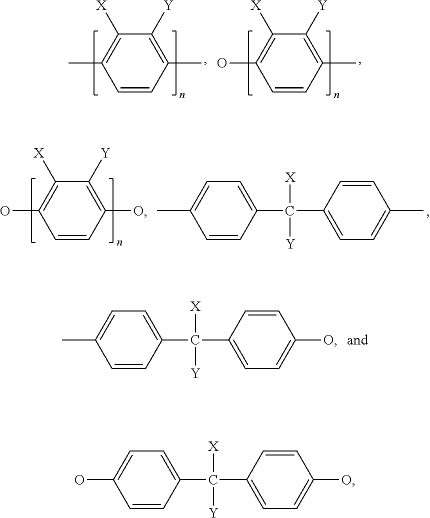
wherein n is a positive integer, X is selected from the group consisting of H, Cl, F, Br, I, OH and CH₄, and Y is selected from the group consisting of H, Cl, F, Br, I, OH and CH₄.

7. The LC panel according to claim 1, wherein each bonding terminal comprises an O atom.

8. The LC panel according to claim 7, wherein the bonding terminal is selected from the group consisting of O—CH₂—C(Z)═CH₂, O—(CH₂)ₙ—O—CO—C(Z)═CH₂, (CH₂)ₙ—O—CO—C(Z)═CH₂, O—(CH₂)ₙ—C(Z)═CH₂, O—(CH₂—CH₂—O)ₙ—CO—C(Z)═CH₂, (CH₂—CH₂—O)ₙ—CO—C(Z)═CH₂, O—(CH₂—CH₂—O)ₙ—C(Z)═CH₂, (CH₂—CH₂—O)ₙ—C(Z)═CH₂, O—CO—C(Z)═CH₂, O—CH₃, O—C₂H₅, and O—H, wherein n is a positive integer and Z is a methyl group or a hydrogen group.

9. The LC panel according to claim 1, wherein the cross-linking terminal is selected from the group consisting of O—CH₂—C(Z)═CH₂, CH₂—C(Z)═CH₂, O—(CH₂)ₙ—O—CO—C(Z)═CH₂, (CH₂)ₙ—O—CO—C(Z)═CH₂, O—(CH₂)ₙ—C(Z)═CH₂, (CH₂)ₙ—C(Z)═CH₂, O—(CH₂—CH₂—O)ₙ—CO—C(Z)═CH₂, (CH₂—CH₂—O)ₙ—CO—C(Z)═CH₂, O—(CH₂—CH₂—O)ₙ—C(Z)═CH₂, (CH₂—CH₂—O)ₙ—C(Z)═CH₂, O—CO—C(Z)═CH₂, O—CH₃, O—C₂H₅, and O—H, wherein n is a positive integer and Z is a methyl group or a hydrogen group.

10. The LC panel according to claim 1, wherein the at least one bonding terminal comprises a first bonding terminal and a second bonding terminal, and each of the vertical alignment molecules further comprises a Si atom for bonding the long-chain alignment terminal, the cross-linking terminal, the first bonding terminal, and the second bonding terminal.

11. The LC panel according to claim 10, wherein the first bonding terminal is selected from the group consisting of O—CH₂—C(Z)═CH₂, O—(CH₂)ₙ—O—CO—C(Z)═CH₂, (CH₂)ₙ—O—CO—C(Z)—CH₂, O—(CH₂)ₙ—C(Z)═CH₂, O—(CH₂—CH₂—O)ₙ—CO—C(Z)═CH₂, (CH₂—CH₂—O)ₙ—CO—C(Z)═CH₂, O—(CH₂—CH₂—O)ₙ—C(Z)═CH₂, (CH₂—CH₂—O)ₙ—C(Z)═CH₂, O—CO—C(Z)═CH₂, O—CH₃, O—C₂H₅, and O—H, and the second bonding terminal is selected from the group consisting of O—CH₂—C(Z)═CH₂, O—(CH₂)ₘ—O—CO—C(Z)═CH₂, (CH₂)ₘ—O—CO—C(Z)═CH₂, O—(CH₂)ₘ—C(Z)═CH₂, O—(CH₂—CH₂—O)ₘ—CO—C(Z)═CH₂, (CH₂—CH₂—O)ₘ—CO—C(Z)═CH₂, O—(CH₂—CH₂—O)ₘ—C(Z)═CH₂, (CH₂—CH₂—O)ₘ—C(Z)═CH₂, O—CO—C(Z)═CH₂, O—CH₃, O—C₂H₅, and O—H, wherein n is a positive integer, m is a positive integer, and Z is a methyl group or a hydrogen group.

12. A liquid crystal display (LCD) apparatus comprising:
a backlight unit; and
a LC panel comprising:
a first substrate and a second substrate opposing the first substrate, arranging the first substrate to face the second substrate;
a LC layer containing a plurality of LC molecules between the first substrate and second substrate; and
a plurality of vertical alignment molecules, each comprising a long-chain alignment terminal, a cross-linking terminal, and at least one bonding terminal;
wherein the at least one bonding terminal couples the vertical alignment molecule to the first or second substrate to form a surface bonding, the long-chain alignment terminals are parallel to each other and perpendicular to the first or second substrate, the cross-linking terminals link the neighboring vertical alignment molecules together, and the LC molecules are vertically aligned between the first substrate and second substrate by means of the long-chain alignment terminals;
wherein the cross-linking terminal has a photo-polymerization group for linking the cross-linking terminals of the neighboring vertical alignment molecules together after exposed to ultra-violet light.

13. The LCD apparatus according to claim 12, wherein each vertical alignment molecule further comprises either a Si atom or an N atom for bonding the long-chain alignment terminal, the cross-linking terminal, and the at least one bonding terminal.

14. The LCD apparatus according to claim 12, wherein the long-chain alignment terminal comprises one of an alkyl group, an alkylene group, and a benzene-ring compound.

15. The LCD apparatus according to claim 14, wherein the alkyl group is selected from the group consisting of CH₃, C₂H₅, C₃H₇, C₄H₉, C₅H₁₁, C₆H₁₃, C₇H₁₅, and C₈H₁₇.

16. The LCD apparatus according to claim 14, wherein the alkylene group is selected from the group consisting of C═C—C═C and C═C—C═C—C═C.

17. The LCD apparatus according to claim 14, wherein the benzene-ring compound is selected from the group consisting of 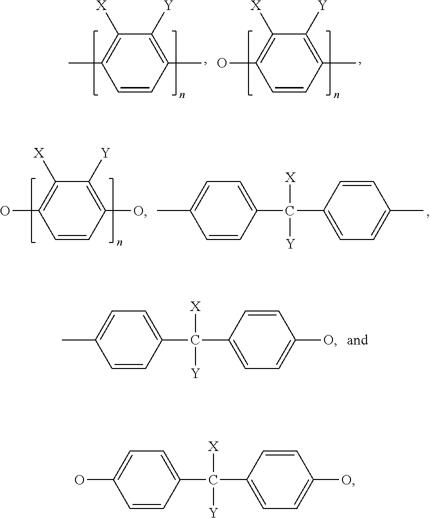
wherein n is a positive integer, X is selected from the group consisting of H, Cl, F, Br, I, OH and CH₄, and Y is selected from the group consisting of H, Cl, F, Br, I, OH and CH₄.

18. The LCD apparatus according to claim 12, wherein each bonding terminal comprises an O atom and the bonding terminal is selected from the group consisting of O—CH₂—C(Z)═CH₂, O—(CH₂)ₙ—O—CO—C(Z)═CH₂, (CH₂)ₙ—O—CO—C(Z)═CH₂, O—(CH₂)ₙ—C(Z)═CH₂, O—(CH₂—CH₂—O)ₙ—CO—C(Z)═CH₂, (CH₂—CH₂—O)ₙ—CO—C(Z)═CH₂, O—(CH₂—CH₂—O)ₙ—C(Z)═CH₂, (CH₂—CH₂—O)ₙ—C(Z)═CH₂, O—CO—C(Z)═CH₂, O—CH₃, O—C₂H₅, and O—H, wherein n is a positive integer and Z is a methyl group or a hydrogen group.

19. The LCD apparatus according to claim 12, wherein the cross-linking terminal is selected from the group consisting of O—CH₂—C(Z)═CH₂, CH₂—C(Z)═CH₂, O—(CH₂)ₙ—O—CO—C(Z)═CH₂, (CH₂)ₙ—O—CO—C(Z)═CH₂, O—(CH₂)ₙ—C(Z)═CH₂, (CH₂)ₙ—C(Z)═CH₂, O—(CH₂—CH₂—O)ₙ—CO—C(Z)═CH₂, (CH₂—CH₂—O)ₙ—CO—C(Z)═CH₂, O—(CH₂—CH₂—O)ₙ—C(Z)═CH₂, (CH₂—CH₂—O)ₙ—C(Z)═CH₂, O—CO—C(Z)═CH₂, O—CH₃, O—C₂H₅, and O—H, wherein n is a positive integer and Z is a methyl group or a hydrogen group.

20. The LCD apparatus according to claim 12, wherein the at least one bonding terminal comprises a first bonding terminal and a second bonding terminal, and each of the vertical alignment molecules further comprises a Si atom for bonding the long-chain alignment terminal, the cross-linking terminal, the first bonding terminal, and the second bonding terminal and the first bonding terminal is selected from the group consisting of O—CH₂—C(Z)═CH₂, O—(CH₂)ₙ—O—CO—C(Z)═CH₂, (CH₂)ₙ—O—CO—C(Z)═CH₂, O—(CH₂)ₙ—C(Z)═CH₂, O—(CH₂—CH₂—O)ₙ—CO—C(Z)═CH₂, (CH₂—CH₂—O)ₙ—CO—C(Z)═CH₂, O—(CH₂—CH₂—O)ₙ—C(Z)═CH₂, (CH₂—CH₂—O)ₙ—C(Z)═CH₂, O—CO—C(Z)═CH₂, O—CH₃, O—C₂H₅, and O—H, and the second bonding terminal is selected from the group consisting of O—CH₂—C(Z)═CH₂, O—(CH₂)ₘ—O—CO—C(Z)═CH₂, (CH₂)ₘ—O—CO—C(Z)═CH₂, O—(CH₂)ₘ—C(Z)═CH₂, O—(CH₂—CH₂—O)ₘ—CO—C(Z)═CH₂, (CH₂—CH₂—O)ₘ—CO—C(Z)═CH₂, O—(CH₂—CH₂—O)ₘ—C(Z)═CH₂, (CH₂—CH₂—O)ₘ—C(Z)═CH₂, O—CO—C(Z)═CH₂, O—CH₃, O—C₂H₅, and O—H, wherein n is a positive integer, m is a positive integer, and Z is a methyl group or a hydrogen group.
